(19) United States
(12) Patent Application Publication
(10) Pub. No.: US 2016/0067848 A1
(43) Pub. Date: Mar. 10, 2016

(54) Socket wrench

(71) Applicants: Dong-Ying Lee, Taichung (TW); Po-Chueh Chen, Taichung (TW)

(72) Inventors: Dong-Ying Lee, Taichung (TW); Po-Chueh Chen, Taichung (TW)

(21) Appl. No.: 14/881,163

(22) Filed: Oct. 13, 2015

(51) Int. Cl. B25B 13/46; B25B 23/00

(52) U.S. Cl. CPC B25B 13/463; B25B 23/0007

(57) ABSTRACT

A socket wrench includes a wrench head including first and second cavities; a reversing lever including spring biased first and second pegs in first and second through holes respectively; first and second reversing pawls each including a detent notch on one surface, a projection, and pawl teeth on the other surface wherein the projections are disposed in a groove between the first through hole and the second through hole, the ends of the first and second pegs urge against the detent notches of the first and second reversing pawls respectively; a drive gear including a spring biased pin in a through opening and having first and second recesses, and a projecting head, external drive teeth in ratcheting engagement with the pawl teeth, a bottom socket having a projecting steel ball in a hole and engaging the second recess; and a split ring in a retaining groove.

### BACKGROUND OF THE INVENTION

1. Field of the Invention

The invention relates to wrenches and more particularly to a socket wrench having improved characteristics.

2. Description of Related Art

A conventional socket and ratchet wrench combination comprising a socket and a ratchet wrench that are detachably connectible to each other through a retainer having a split ring to provide nut driving even when a threaded shank extends outward from the nut being torqued.

While the device enjoys its success in the market, continuing improvements in the socket wrench of this type are constantly sought.

### SUMMARY OF THE INVENTION

It is therefore one object of the invention to provide a socket wrench comprising a handle; a wrench head including a first cavity, a second cavity communicating with the first cavity; a reversing lever disposed in the second cavity and including a stepped diameter first through hole, a stepped diameter second through hole, a spring biased first peg in the first through hole and having an end projecting out of the first through hole, a spring biased second peg in the second through hole and having an end projecting out of the second through hole, and a thumb tab; a first reversing pawl disposed in the first cavity and including a detent notch on a first surface, a projection projecting out of the detent notch, and pawl teeth on a second surface opposing the first surface; a second reversing pawl disposed in the first cavity and including a detent notch on a first surface, a projection projecting out of the detent notch of the second reversing pawl, and pawl teeth on a second surface opposing the first surface of the second reversing pawl wherein the first reversing pawl is disposed on the second reversing pawl, the projection of the first reversing pawl is disposed on the projection of the second reversing pawl, the projections are disposed in a groove between the first through hole and the second through hole, the end of the first peg urges against the detent notch of the first reversing pawl, and the end of the second peg urges against the detent notch of the second reversing pawl; a drive gear including an axial through opening, a spring biased pin partially disposed in the through opening, the pin having a first recess, a second recess having a depth less than a depth of the first recess, and a head projecting out of the first cavity, external drive teeth in ratcheting engagement with both the pawl teeth of the first reversing pawl and the pawl teeth of the second reversing pawl, a bottom socket having a hole communicating with the through opening, and a steel ball engaging the second recess in an inoperative position and partially projecting out of the hole; and a split ring disposed in an annular retaining groove on an inner surface of the first cavity, the split ring having two bent ends anchored in a well on a bottom of the wrench head.

The above and other objects, features and advantages of the invention will become apparent from the following detailed description taken with the accompanying drawings.

### BRIEF DESCRIPTION OF THE DRAWINGS

FIG. 1 is a perspective view of a socket wrench according to the invention;

FIG. 2 is an exploded view of the wrench head viewed from the top;

FIG. 3 is an exploded view of the wrench head viewed from the bottom;

FIG. 4 is a fragmentary view of the wrench head with the reversing lever to be disposed in the second cavity;

FIG. 5 is a fragmentary view of the wrench head with the first and second reversing pawls to be disposed in a portion of the first cavity and held in the groove;

FIG. 6 is an exploded view showing the projections of the first and second reversing pawls to be fitted in the groove;

FIG. 7 is a fragmentary view of the wrench head with the drive gear to be disposed in the first cavity to be in ratcheting engagement with the pawl teeth of the first and second reversing pawls;

FIG. 8 is a fragmentary view of the wrench head with the splint ring to be anchored in the annular retaining groove on an inner surface of the first cavity proximate to a bottom opening of the first cavity; and

FIG. 9 is a perspective view of the wrench head viewed from the bottom.

### DETAILED DESCRIPTION OF THE INVENTION

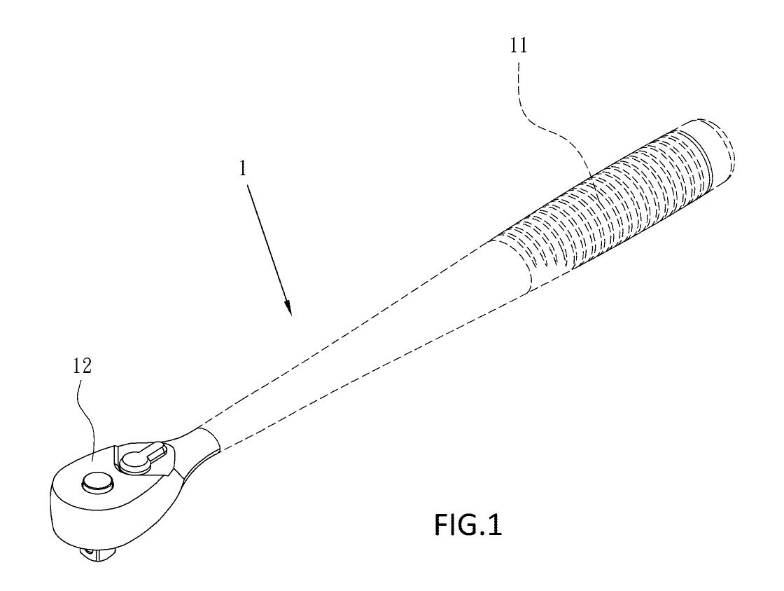

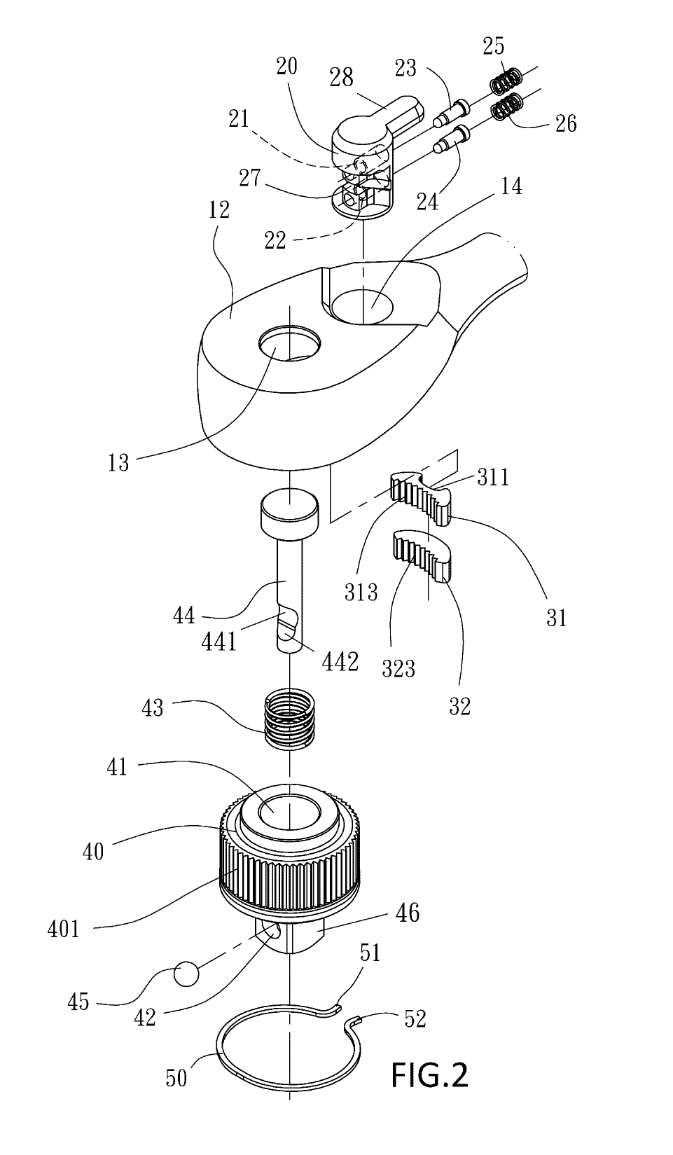

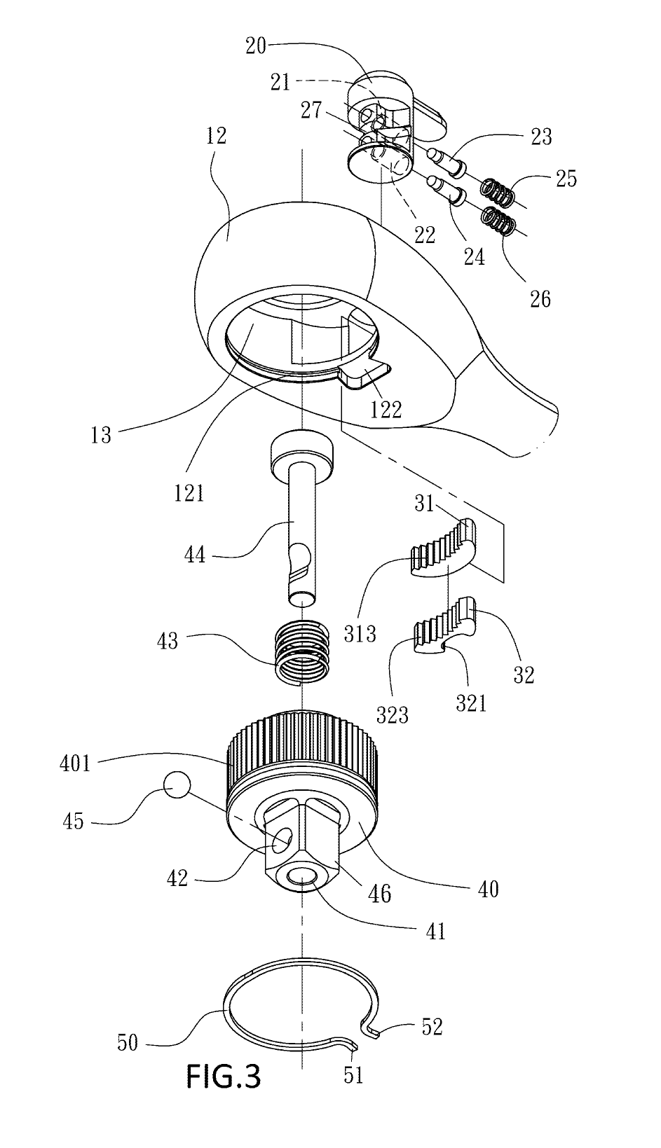

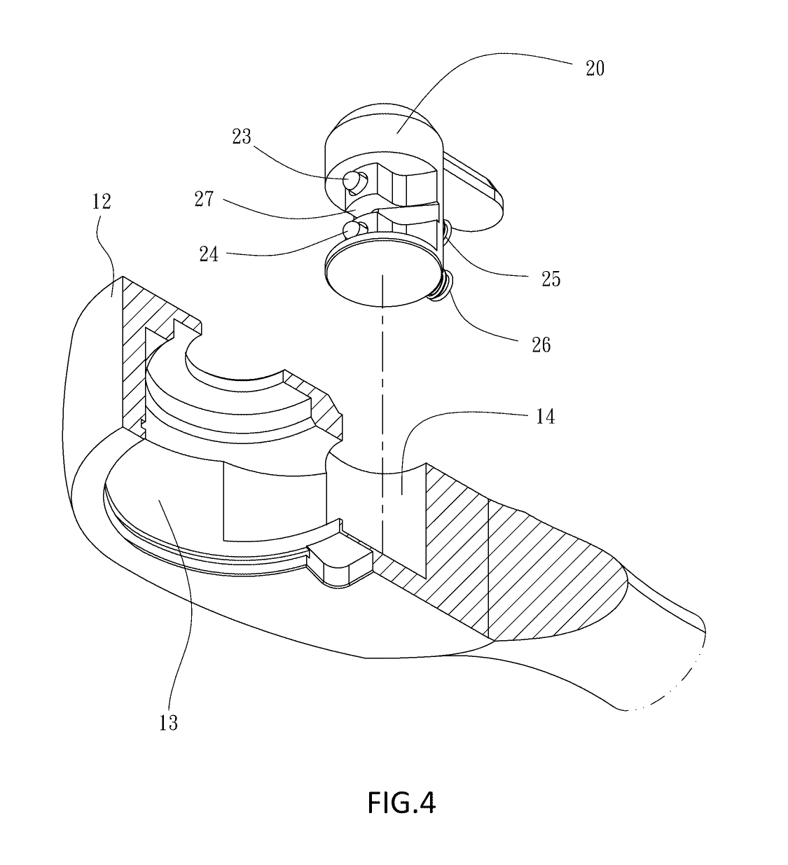

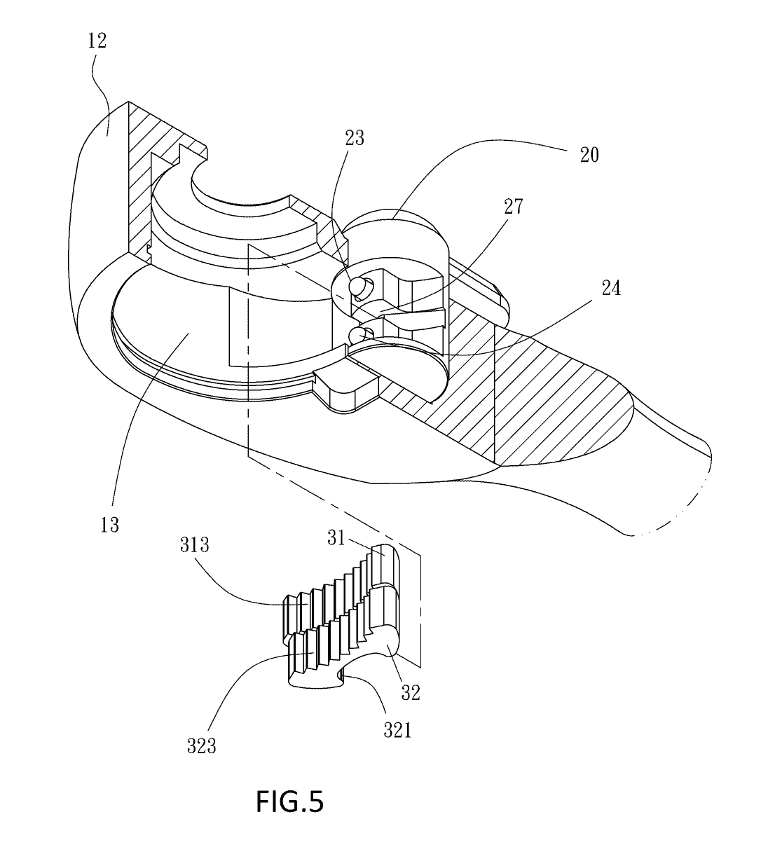

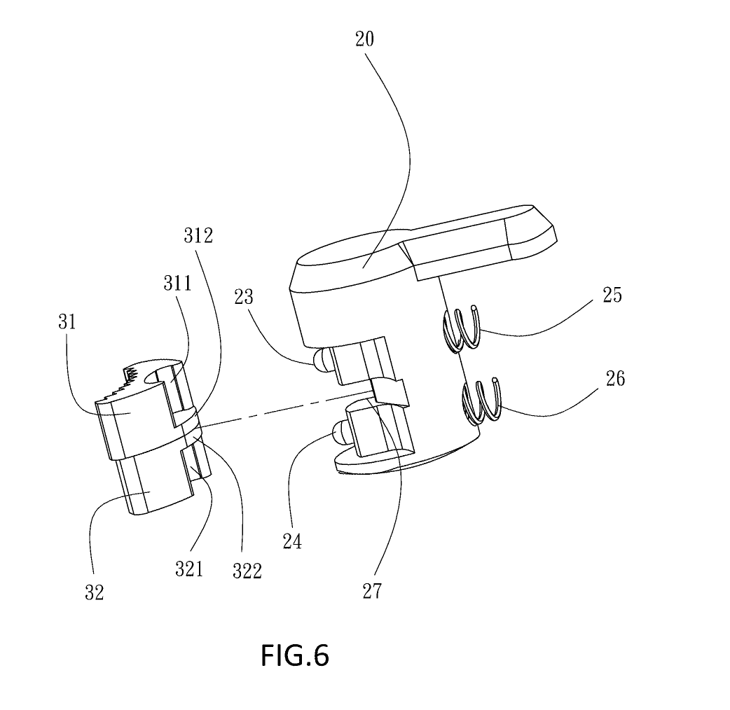

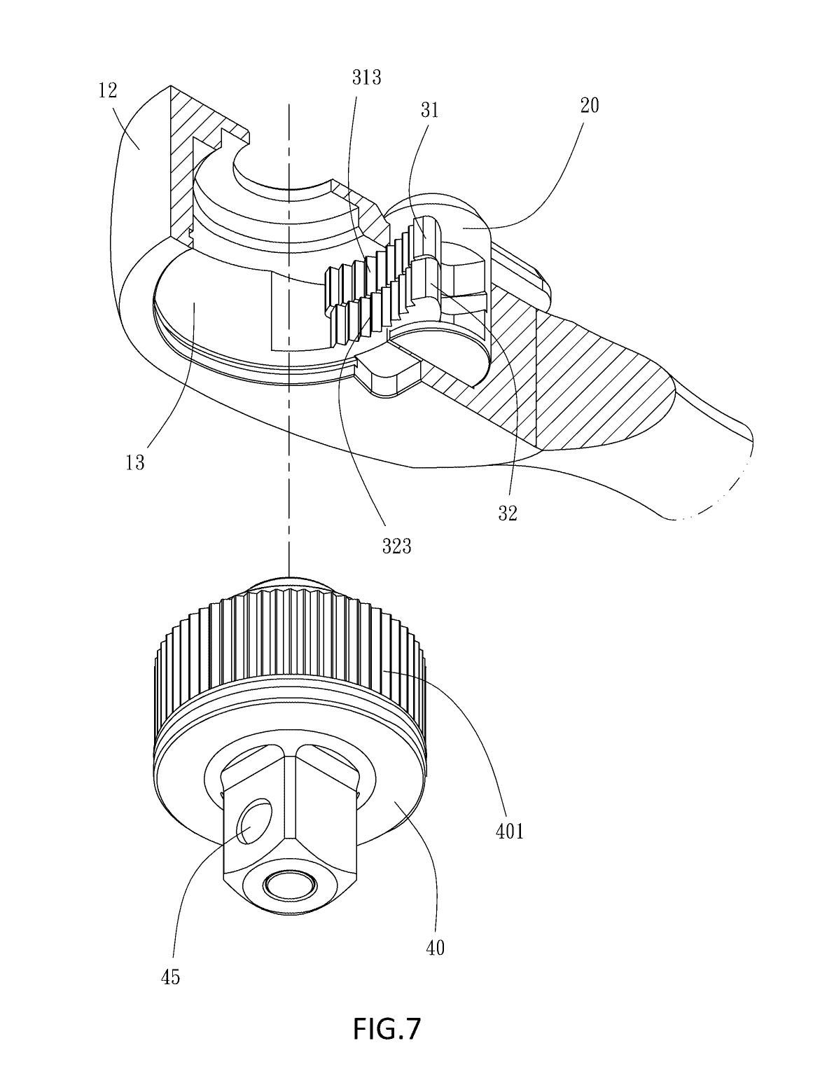

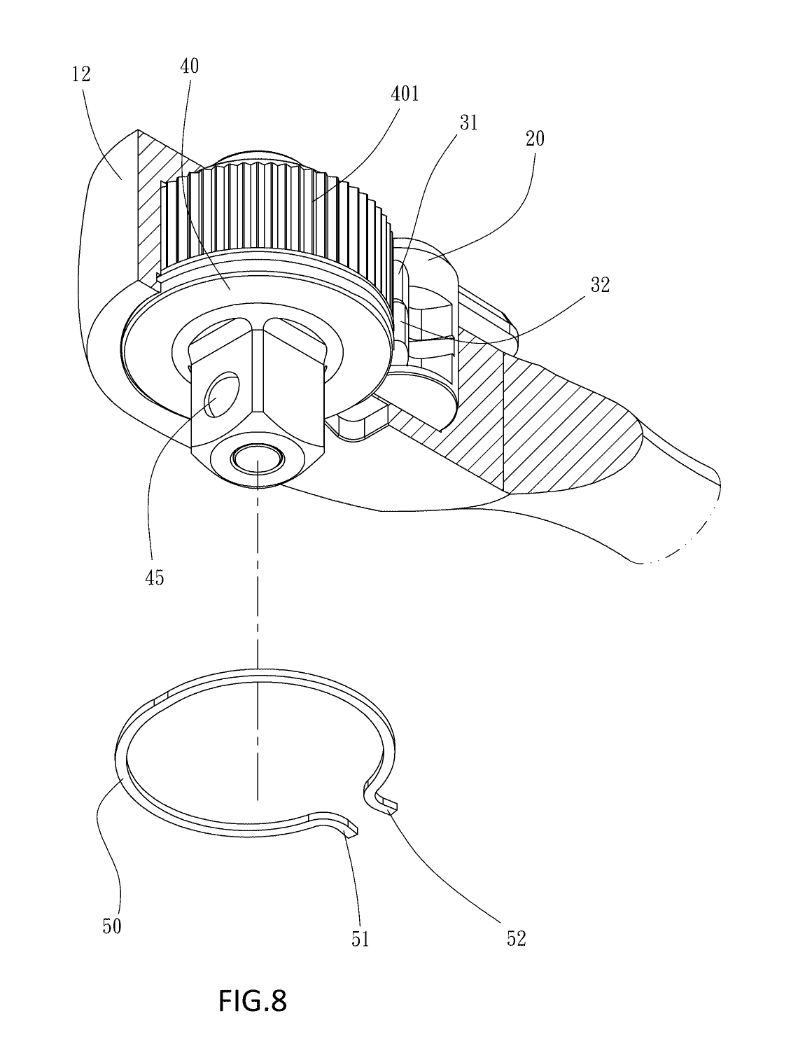

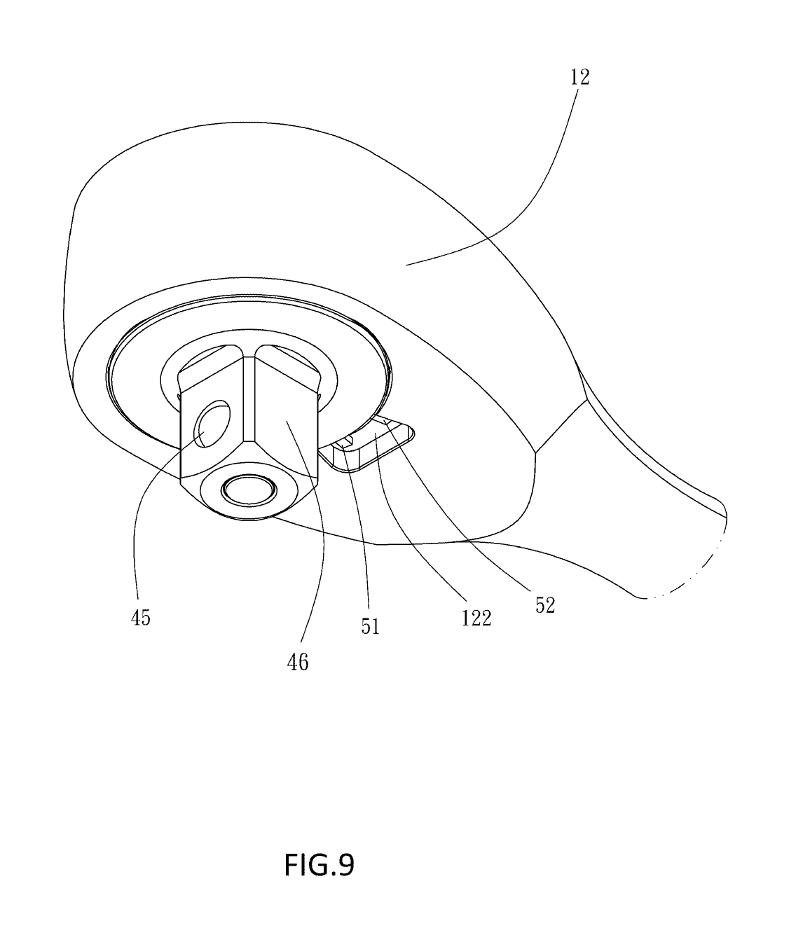

Referring to FIGS. 1 to 9, a socket wrench 1 in accordance with the invention comprises the following components as discussed in detail below.

A handle 11 and a wrench head 12 are provided. The wrench head 12 includes a first cavity 13 and a second cavity 14 communicating with the first cavity 13. A reversing lever 20 is disposed in the second cavity 14 and includes a stepped diameter first through hole 21, a stepped diameter second through hole 22, a first peg 23 in the stepped diameter first through hole 21 and having its end projecting out of the stepped diameter first through hole 21, a second peg 24 in the stepped diameter second through hole 22 and having its end projecting out of the stepped diameter second through hole 22, a first helical spring 25 having one end anchored on the second cavity 14 and the other end biasing against the head of the first peg 23, a second helical spring 26 having one end anchored on the second cavity 14 and the other end biasing against the head of the second peg 24, and a thumb tab 28.

A first reversing pawl 31 includes a detent notch 311 on one surface, a projection 312 projecting out of the detent notch 311, and pawl teeth 313 on the other opposite surface. A second reversing pawl 32 includes a detent notch 321 on one surface, a projection 322 projecting out of the detent notch 321, and pawl teeth 323 on the other opposite surface. The first reversing pawl 31 is disposed on the second reversing pawl 32. Further, the projection 312 is disposed on the projection 322. The first and second reversing pawls 31, 32 are disposed in the first cavity 13. The projections 312, 322 are disposed in a groove 27 between the first through hole 21 and the second through hole 22. The end of the first peg 23 urges against the detent notch 311 and the end of the second peg 24 urges against the detent notch 321 respectively.

A drive gear 40 includes an axial through opening 41, a helical spring 43 in the through opening 41, a pin 44 partially disposed in the spring 43, the pin 44 having a first recess 441, a second recess 442 having a depth less than a depth of the first recess 441, and a head projecting out of the first cavity 13, external drive teeth 401 in ratcheting engagement with both the pawl teeth 313 and the pawl teeth 323, a socket 46 having a square section and projecting out of a bottom, a hole 42 in the socket 46 and communicating with the through opening 41, and a steel ball 45 engaging the second recess 442 in an inoperative position and partially projecting out of the hole 42. A split ring 50 is disposed in an annular retaining groove 121 on an inner surface of the first cavity 13 proximate to a bottom opening of the first cavity 13. The split ring 50 has two bent ends 51, 52 anchored in a well 122 on a bottom of the wrench head 12, the well 122 communicating with the retaining groove 121.

For example, a user may turn the thumb tab 28 counterclockwise. And in turn, the first and second pegs 23, 24 push and counterclockwise pivot both the first and second reversing pawls 31, 32. And in turn, the drive gear 40 rotates clockwise. As a result, a bolt (not shown) put on the socket 46 is tightened.

The user may press the pin 44 to move the steel ball 45 from the position of the second recess 442 to that of the first recess 441. The steel ball 45 thus retracts to unfasten the bolt.

While the invention has been described in terms of preferred embodiments, those skilled in the art will recognize that the invention can be practiced with modifications within the spirit and scope of the appended claims.

What is claimed is:

1. A socket wrench comprising:
a handle;
a wrench head including a first cavity and a second cavity communicating with the first cavity;
a reversing lever disposed in the second cavity and including a stepped diameter first through hole, a stepped diameter second through hole, a spring biased first peg in the first through hole and having an end projecting out of the first through hole, a spring biased second peg in the second through hole and having an end projecting out of the second through hole, and a thumb tab;
a first reversing pawl disposed in the first cavity and including a detent notch on a first surface, a projection projecting out of the detent notch, and pawl teeth on a second surface opposing the first surface;
a second reversing pawl disposed in the first cavity and including a detent notch on a first surface, a projection projecting out of the detent notch of the second reversing pawl, and pawl teeth on a second surface opposing the first surface of the second reversing pawl wherein the first reversing pawl is disposed on the second reversing pawl, the projection of the first reversing pawl is disposed on the projection of the second reversing pawl, the projections of the first and second reversing pawls are disposed in a groove between the first through hole and the second through hole, the end of the first peg urges against the detent notch of the first reversing pawl, and the end of the second peg urges against the detent notch of the second reversing pawl;
a drive gear disposed in the first cavity and including a through opening, a spring biased pin partially disposed in the through opening, the pin having a first recess, a second recess having a depth less than a depth of the first recess, and a head projecting out of the first cavity, external drive teeth in ratcheting engagement with both the pawl teeth of the first reversing pawl and the pawl teeth of the second reversing pawl, a bottom socket having a hole communicating with the through opening, and a steel ball engaging the second recess in an inoperative position and partially projecting out of the hole; and
a split ring disposed in an annular retaining groove on an inner surface of the first cavity, the split ring having two bent ends anchored in a well on a bottom of the wrench head.
